(19) United States
(12) Patent Application Publication
(10) Pub. No.: US 2026/0018824 A1
(43) Pub. Date: Jan. 15, 2026

(54) Banana Plug Split Nut Retainer

(71) Applicant: NATIONAL INSTRUMENTS CORPORATION, Austin, TX (US)

(72) Inventor: Jacob Friedrich, Austin, TX (US)

(21) Appl. No.: 19/265,843

(22) Filed: Jul. 10, 2025

Related U.S. Application Data
(60) Provisional application No. 63/670,687, filed on Jul. 12, 2024.

(51) Int. Cl. H01R 13/506; H01R 13/207; H01R 13/622; H01R 24/28

(52) U.S. Cl. CPC H01R 13/506; H01R 13/207; H01R 13/622; H01R 24/28

(57) ABSTRACT

An apparatus for securely retaining a high voltage (e.g., greater than 1000 volts) banana plug can include a clamshell apparatus. The clamshell apparatus can include a first segment that includes a one or more mating pegs and a first threaded portion and a second segment that includes one or more mating slots and a second threaded portion. The first segment and the second segment can be configured to be assembled via a press-fit of the first segment to the second segment over a banana plug. In addition, when assembled, the first threaded portion and the second threaded portion are aligned to form a threaded fastener that is configured to retain the banana plug in a banana socket when engaged with a corresponding mating flange via the threaded fastener.

### PRIORITY CLAIM

This application claims priority to U.S. Provisional Patent Application No. 63/670,687, titled “Banana Plug Split Nut” and filed Jul. 12, 2024, which is hereby incorporated by reference in its entirety as though fully and completely set forth herein.

### TECHNICAL FIELD

The invention relates to the area of high voltage connectors, and more particularly to apparatuses for securely retaining a high voltage (e.g., greater than 1000 volts) banana plug, e.g., in test and measurement systems.

### DESCRIPTION OF THE RELATED ART

Within the testing industry, banana connectors are considered spring-loaded, single-wire (conductor) electrical test connectors used for joining wire to electrical equipment or electrical circuit boards via a mating of a banana plug to a banana socket. A banana plug plugs directly into a banana socket (often referred to as a banana jack). Popular testing equipment and test accessories such as leads and cables use a banana connection. A banana plug is considered a male connector and is called a banana because of its unique contact tip. The banana plug is a cylindrical pin that has “metal-leaves” that bulge outward to produce a strong connectivity contact (snug fit) in a socket to prevent the pin from disconnecting or falling out. Banana plugs often connect to a wire that can be soldered, crimped, or screwed into place. Many banana plugs are also available as adapters, offering a plug to another connection style.

There are many types of banana plugs offering different combinations and styles or features used for testing equipment and other applications. Each style is for use with different voltages and applications, often to personal preference or equipment requirements. An advantage of banana plugs is that they are easy to use and can provide a secure and reliable connection, can be stacked or daisy-chained together, allowing multiple connections with one socket. This feature is helpful for testing or measuring multiple circuits or devices.

However, banana plugs also have some limitations and challenges. One of the main drawbacks of banana plugs is that they are not standardized and can vary in size, shape, and quality. Some banana plugs may not fit well with some banana sockets, causing loose or intermittent connections. Some banana plugs may also have poor insulation or shielding, which can result in noise or interference. Additionally, some banana plugs may not be compatible with some safety regulations or requirements, especially for high-voltage or high-current applications. Therefore, improvements are desirable.

### SUMMARY

Embodiments described herein relate to high voltage connectors, and more particularly to apparatuses for securely retaining a high voltage (e.g., greater than 1000 volts) banana plug, e.g., in test and measurement systems.

For example, in some embodiments, a clamshell apparatus can include a first segment (e.g., a first portion of a clamshell) that includes a one or more mating pegs and a first threaded portion and a second segment (e.g., a second portion of a clamshell) that includes one or more mating slots and a second threaded portion. The first segment and the second segment can be configured to be assembled via a press-fit of the first segment to the second segment over a banana plug via the first one or more mating pegs arranged on the first segment and corresponding to the first one or more mating slots arranged on the second segment. In addition, when assembled, the first threaded portion and the second threaded portion are aligned to form a threaded fastener that is configured to retain the banana plug in a banana socket when engaged with a corresponding mating flange via the threaded fastener.

As another example, in some embodiments, a mating flange can include at least first internal threads configured to mate to an assembled clamshell apparatus and one or more mounting holes configured to mount the mating flange over a banana socket. Thus, the assembled clamshell apparatus can be threaded into the mating flange to retain a banana plug in the banana socket. In addition, the mating flange can further include second internal threads configure to mate to another assembled clamshell apparatus.

As a further example, a banana plug retention system can include a clamshell apparatus and a mating flange. The clamshell apparatus can include a first segment (e.g., a first portion of a clamshell) that includes a one or more mating pegs and a first threaded portion and a second segment (e.g., a second portion of a clamshell) that includes one or more mating slots and a second threaded portion. The mating flange can include at least first internal threads configured to mate to an assembled clamshell apparatus and one or more mounting holes configured to mount the mating flange over a banana socket. The first segment and the second segment can be configured to be assembled via a press-fit of the first segment to the second segment over a banana plug via the first one or more mating pegs arranged on the first segment and corresponding to the first one or more mating slots arranged on the second segment. In addition, when assembled, the first threaded portion and the second threaded portion are aligned to form a threaded fastener that is configured to retain the banana plug in a banana socket when engaged with the mating flange via the threaded fastener and the first internal threads.

Note that the techniques described herein may be implemented in and/or used with a number of different types of devices, including but not limited to signal generators, test and measurement systems, cellular phones, tablet computers, wearable computing devices, portable computing devices, portable media players, and any of various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the disclosed embodiments can be obtained when the following detailed description of the preferred embodiments is considered in conjunction with the following drawings.

FIG. 1A illustrates an example of a banana plug.

FIG. 1B illustrates an example of a banana plug with an insulation cap.

FIG. 1C illustrates an example of a banana plug with a twist lock mechanism.

FIGS. 2A and 2B illustrate an example of a banana split nut connector, according to some embodiments.

FIGS. 3A-3C illustrate various views of portions of a banana split nut assembly, according to some embodiments.

FIGS. 4A-4E illustrate examples of various aspects of a clamshell apparatus, according to some embodiments.

FIGS. 5A-5C illustrate examples of various stages of assembly of a clamshell apparatus over a banana plug, according to some embodiments.

FIGS. 6A-6H illustrate examples of various aspects of a mating flange, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Banana Connector—Refers to a spring-loaded, single-wire (conductor) electrical test connector used for joining wire to electrical equipment or electrical circuit boards. A banana connector generally includes male (plug) and female (socket) portions. In a banana connector, a cylindrical pin (plug) that has “metal-leaves” (e.g., leaf springs) that bulge outward inserts into a socket. The metal-leaves produce a strong connectivity contact (snug fit) in a socket and provide some retention of the cylindrical pin in the socket.

Banana Plug—Refers to a male portion of a banana connector. A banana plug can be generally described as a cylindrical pin (plug) that has “metal-leaves” (e.g., leaf springs) that bulge outward inserts into a socket. The metal-leaves produce a strong connectivity contact (snug fit) in a socket and provide some retention of the cylindrical pin in the socket.

Banana Socket—Refers to a female portion of a banana connector A banana socket can be generally described as a cylindrical cavity that mates to a cylindrical pin (plug) that has “metal-leaves” (e.g., leaf springs) that bulge outward inserts into a socket. The metal-leaves produce a strong connectivity contact (snug fit) in the banana socket and provide some retention of the cylindrical pin in the socket.

Device Under Test (DUT) or Unit Under Test (UUT)—A physical device or component that is being tested.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Banana Plug Split Nut

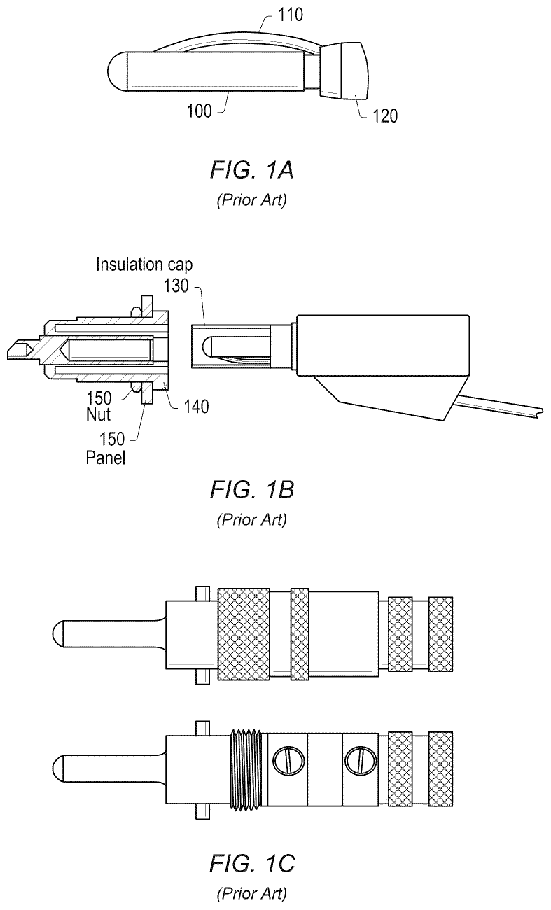

Banana connectors are a spring-loaded, single-wire (conductor) electrical test connector used for joining wire to electrical equipment or electrical circuit boards. Banana connectors typically include two parts, a banana plug and a banana socket. A banana plug plugs directly into a banana socket (often referred to as a banana jack). As shown in FIG. 1A, a banana plug is a cylindrical pin that has one or more spring rods (e.g., “metal-leaves”) that bulge outward to produce a strong connectivity contact (snug fit) in a banana socket to prevent the cylindrical pin from disconnecting or falling out. As shown, the banana plug may include a cylindrical pin 100, one or more spring rods 110 (e.g., such as a beryllium copper spring rod or leaf spring), and a rear body 120 (e.g., for allowing connection to a wire). Banana plugs often connect to a wire that can be soldered, crimped, or screwed into place. Many banana plugs are also available as adapters, offering a plug to another connection style.

There are various styles of banana plugs. For example, for high voltage applications, a banana plug may include an insulation cap as shown in FIG. 1B. As shown, an insulation cap 130 can envelop the pin of the banana plug. In addition, as shown, the banana plug may engage with a banana socket 140. The banana socket can be fitted within a panel 150 and secured from behind the panel by a nut 160. As another example, in audio applications, a banana plug may include a twist lock mechanism, as shown in FIG. 1C. As shown, the body of the banana plug can include radially positioned pins that can be used to secure the banana plug in a corresponding banana socket. However, these styles of banana plugs may require a corresponding modified banana socket. For example, as shown in FIG. 1B, a standard banana socket needs to be modified to account for the insulation cap. Similarly, to accommodate the twist-lock mechanism of the banana plug of FIG. 1C, a banana socket must incorporate a slot to engage to twist lock mechanism. Thus, a standard banana socket is not suitable for use in such applications that include the twist-lock mechanism.

Currently, it is difficult to source a high voltage (e.g., greater than 1000 volts) connector that includes a latching feature (e.g., a non-permanent locking mechanism). Typically, in test and measurement, a banana connector is used for high voltage connections, however, banana connectors suitable for high voltage typically do not have a latching feature, just a retention feature via metal leaves/leaf type springs on the banana plug portion of the banana connector. In other words, a banana plug easily pushes in and pulls out of a banana socket, similar to a power plug or a universal serial bus (USB) connector. However, without a latching feature, such a connection may not be safe for high voltage applications, especially considering that the banana plug fit may become less secure with repeated use (e.g., leaf type springs may wear and not provide as much resistance to dislodging overtime). Therefore, improvements are desired.

Embodiments described herein provide a latching mechanism for a banana connector, e.g., for high voltage (e.g., greater than 1000 volts) test and measurement applications. For example, a banana split nut may screw down over the back of a standard banana plug, thereby providing a latching mechanism and preventing the standard banana plug from being pulled out of a corresponding banana socket. In some instances, the banana split nut may include and/or be a clamshell that fits over a standard banana plug and threads into a mating flange installed over a banana socket. Once secured, the clamshell may not be removed unless it is unscrewed from the flange, e.g., once secured, the clamshell provides a latching mechanism for a standard banana connector.

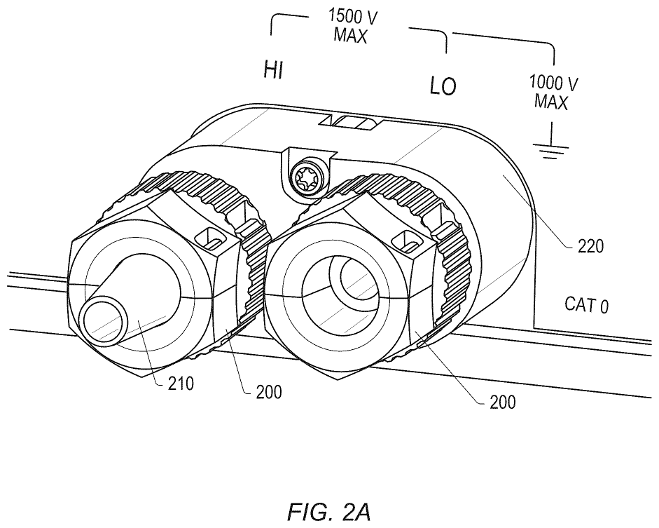

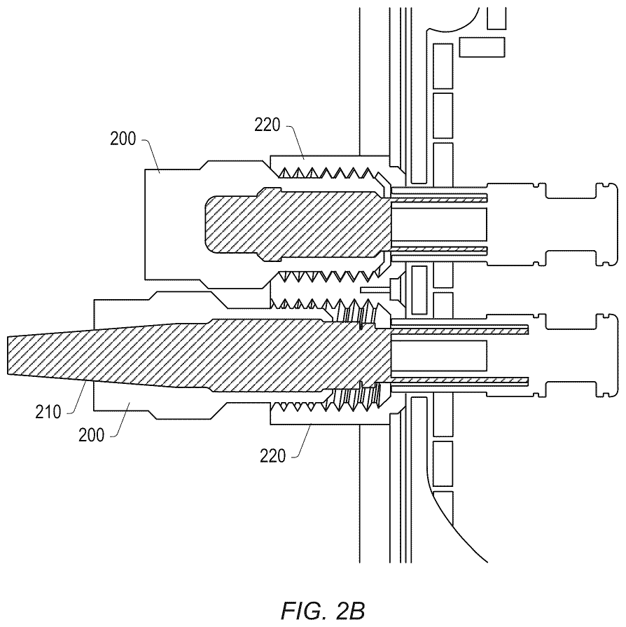

FIGS. 2A and 2B illustrate an example of a banana split nut connector, according to some embodiments. As shown in FIG. 2A, the banana split nut connector may include a clamshell apparatus 200 that fits over standard banana plugs. Further, as shown, banana plugs may come in a variety of different styles, including a strain relief element 210, at least in some instances. However, the clamshell is configured to fit over these various standard styles. Additionally, as shown, the clamshell apparatus 200 can be configured to thread onto a mating flange 220 installed over a banana socket. In the instance illustrated, the banana socket is secured to a panel supporting a high voltage application.

FIG. 2B illustrates a cross-section view of the clamshell apparatus 200 and mating flange 220. As shown, the clamshell apparatus 200 can include a tapered back or rear section that can be configured to clamp down onto a back of a banana plug (e.g., such as onto strain relief element 210 and/or directly onto the back of the banana plug). Once clamped, the clamshell apparatus 200 can be threaded (e.g., screwed) into the mating flange 220. In such a manner, a banana plug can be securely fixed to a device/panel. Note that bottoming out (e.g., full tightening) of the clamshell apparatus 200 can occur on a connector interface of the banana plug or between the clamshell apparatus 200 and the mating flange 220.

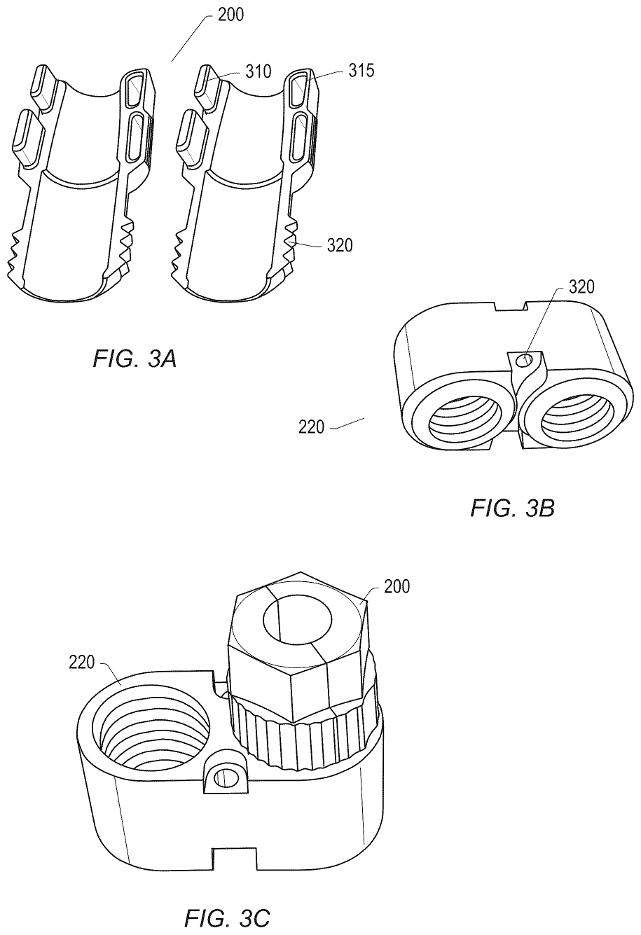

FIGS. 3A, 3B, and 3C illustrate various views of portions of a banana split nut, according to some embodiments. As shown in FIG. 3A, a clamshell apparatus 200 can include at least two sections. As shown, a section can include one or more mating pegs 310 and a corresponding one or more mating slots 315. In addition, the section can include a threaded portion, where the threaded portion is configured to align with another section when respective pegs of the section are aligned with respective slots of the other section and respective pegs of the other section are aligned with respective slots of the section. Further, as can be seen in FIG. 3A, a portion of each section is tapered such an inner radius of the clamshell apparatus 200 decreases along a longitudinal axis moving away from the threaded portion of the clamshell apparatus 200. As shown in FIG. 3B, a mating flange 220 can include threaded receptacles for one or more clamshell apparatuses 200. As shown, the mating flange 220 can be configured to be secured over a banana socket via at least one through hole 320. FIG. 3C illustrates an assembled banana split nut. As shown, the banana split nut can include at least one clamshell apparatus 200 and at least one mating flange 220.

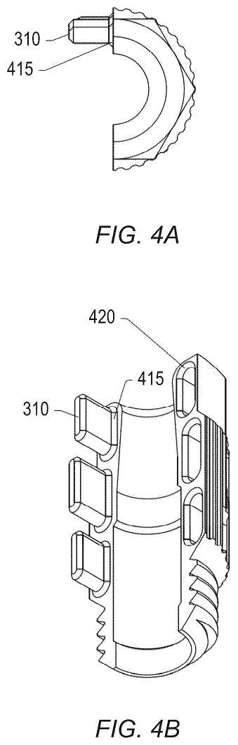

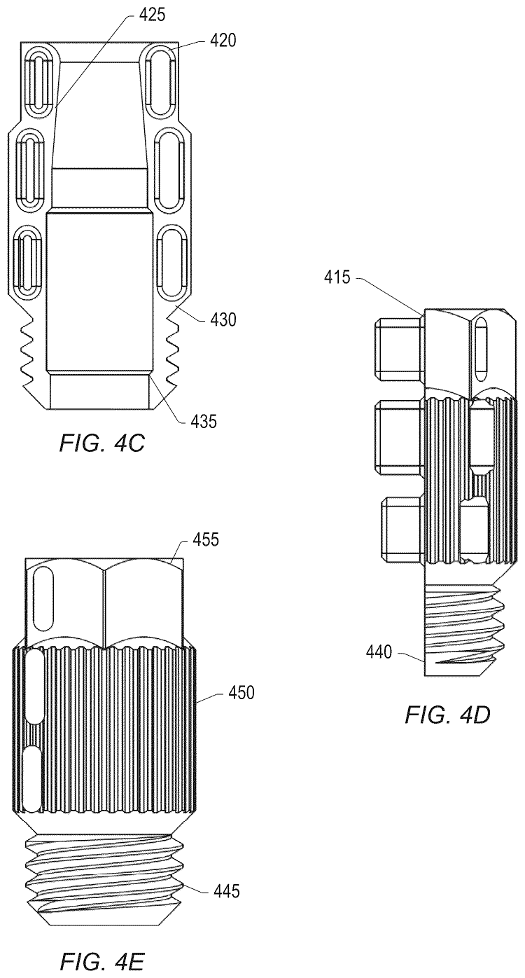

FIGS. 4A-4E illustrate examples of various aspects of a clamshell apparatus, according to some embodiments. For example, FIG. 4A illustrates a top view of a portion of a clamshell apparatus, such as clamshell apparatus 200 described above. As shown in FIG. 4A, a mating peg 310 may be configured to allow for a press-fit assembly with a corresponding mating slot. In some instances, to case assembly the mating peg 310 can include a beveled top portion, as shown. Further, as shown, the mating peg 310 can include a beveled shoulder 415 at its base to allow for a secure fit with the corresponding mating slot. As further illustrated in FIG. 4B, a mating slot 315 can include a beveled top portion 420 that corresponds to the beveled shoulder 415. FIG. 4C illustrates a first side view of a portion of a clamshell apparatus, such as clamshell apparatus 200. As shown, the portion of the clamshell apparatus can include a tapered inner diameter 425. The tapered inner diameter 425 can be configured to accommodate a wide range of banana plug connectors by allowing for a varying mating depth to a banana plug connector. Further, the portion of the clamshell apparatus can include a taper 430 configured to allow an assembled banana split nut to self-center in a corresponding mounting flange. In addition, the portion of the clamshell apparatus can include a retaining lip 435. The retaining lip 435 can be configured to provide a minimal amount of retention of an assembled banana split nut at a front of the banana split nut. Such retention can allow the assembled banana split nut to retain a banana plug even when unplugged. FIG. 4D illustrates a second side view of a portion of a clamshell apparatus, such as clamshell apparatus 200. As shown, the portion of the clamshell apparatus can be constructed with a smooth/flush side 440 to allow the clamshell apparatus to be manufactured via a molding process. FIG. 4E illustrates a third side view of a portion of a clamshell apparatus, such as clamshell apparatus 200. As shown, the portion of the clamshell apparatus can include radial knurling 450 and hex pattern 455 to allow for various forms of tightening. For example, the hex pattern 455 can support wrench tightening into a corresponding mating flange whereas radial knurling 450 can support finger or hand tightening into the corresponding mating flange. In addition, the portion of the clamshell apparatus can include threads 445. The threads 445 can take any of various forms. For example, the threads 445 can be dual-chased threads supporting a hermaphroditic mating to the corresponding mating flange, single-chased threads (note that hermaphroditic mating cannot be supported by single-chased threads), buttress threads, and/or cut down threads supporting quarter-turn fastening to the corresponding mating flange.

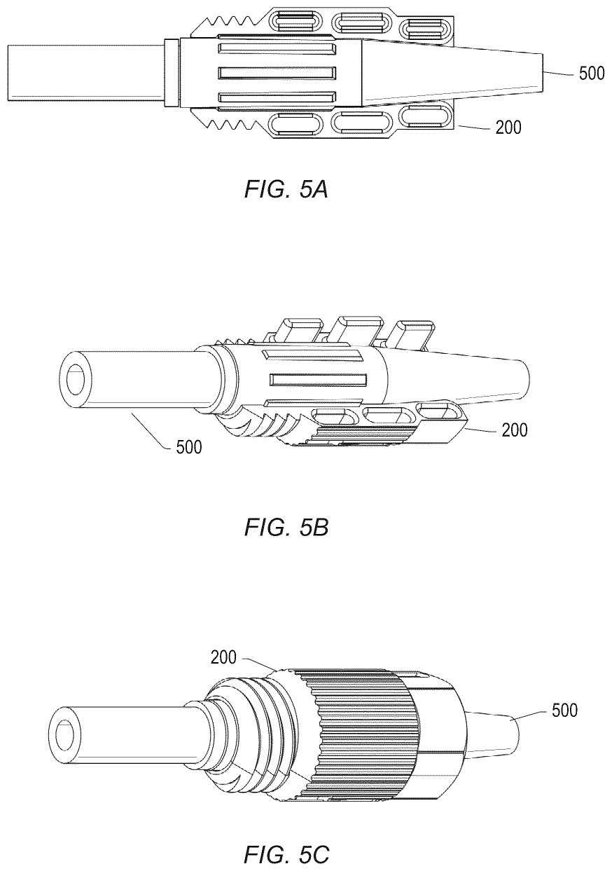

FIGS. 5A-5C illustrate examples of various stages of assembly of a clamshell apparatus over a banana plug, according to some embodiments. For example, FIGS. 5A and 5B illustrate side views of a first clamshell apparatus 200 fitted over a banana plug 500. FIG. 5C illustrates an assembled banana split nut over a banana plug 500. As shown, the assembled banana split nut includes a first clamshell apparatus 200 mated to a second clamshell apparatus 200. The first clamshell apparatus 200 and the second clamshell apparatus 200 can be mated via matting pegs 310 and matting slots 315.

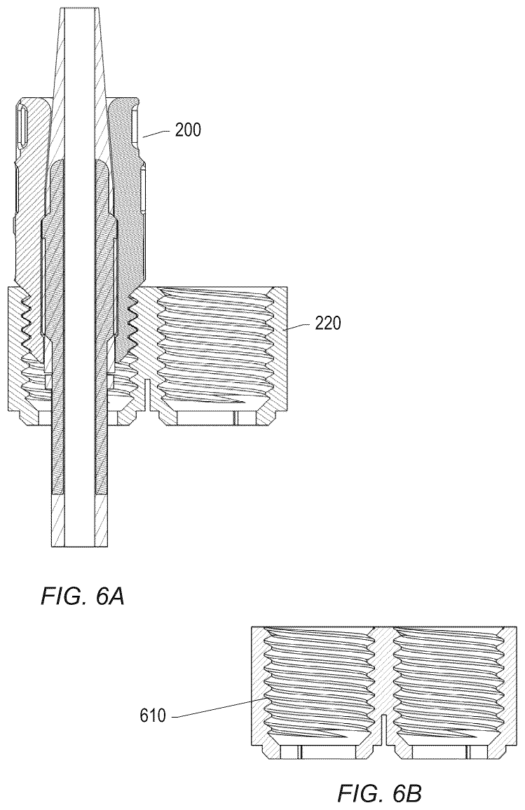

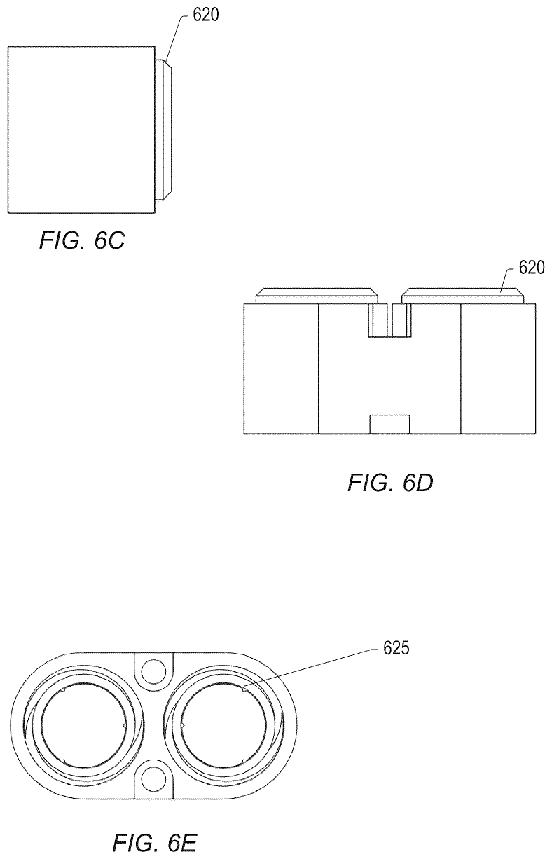

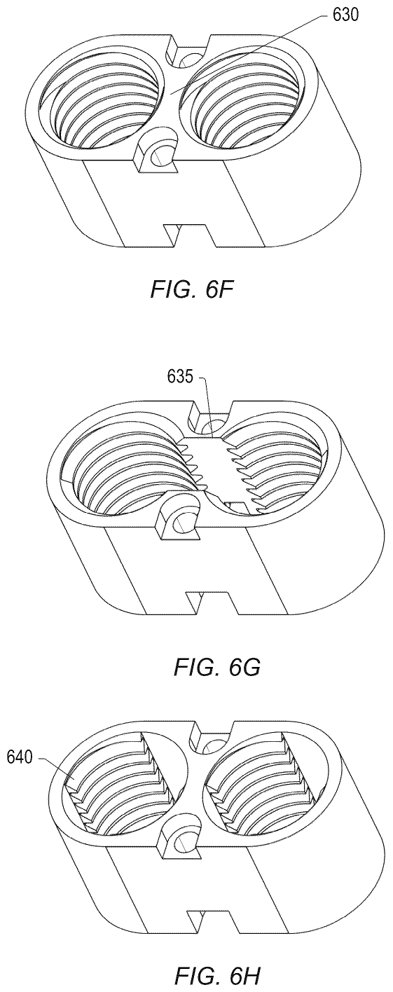

FIGS. 6A-6H illustrate examples of various aspects of a mating flange, according to some embodiments. FIGS. 6A and 6B illustrate examples of cross-sectional views of a mating flange 220. As shown, the mating flange 220 can be configured to couple to multiple assembled banana split nuts. For example, the example cross-sectional view of FIG. 6A illustrates one assembled banana split nut threaded into one side of the mating flange 220. The cross-section view further illustrates a clamshell apparatus 200 engaging with the mating flange 220. In some instances, a buttress thread can use an asymmetric profile, e.g., to increase tensile/pull strength of the threads. Additionally, the asymmetric profile can reduce an overall thread depth, e.g., due to increased tensile/pull strength as compared to a symmetrical thread. As shown in FIG. 6B, in some instances, internal threads 610 are configured to clamp together the assembled banana split nut which can aid the assembled banana nut in resisting prying apart under load. In some instances, internal threads 610 can be custom dual chased threads or a standard thread. FIGS. 6C, 6D, and 6E illustrate examples of various two-dimensional views of the mating flange 220. As shown in FIGS. 6C and 6D, reduced diameter 620 on the face opposite the mating surface to the assembled banana split nut (e.g., the face mounting to a panel containing a banana socket) can allow for easier installation in a panel/enclosure, e.g., due to reducing a size of a clearance hole for the mating flange 220. Further, the reduced diameter 620 can serve as a centering mechanism for the mating flange 220. As shown in FIG. 6E, centering pins 625 can aid in locating and/or guiding a banana plug into a corresponding banana socket. FIGS. 6F, 6G, and 6H illustrate examples of various configurations of the mating flange 220. For example, as shown in FIG. 6F, the mating flange 220 can have a full center wall separating mounting holes for assembled banana split nuts and the mounting holes can be fully threaded. As shown in FIG. 6G, the mating flange 220 can have the center wall removed between mounting holes for assembled banana split nuts. Such a configuration can allow for the use of ganged connector. In some instances, a threaded disk can be installed with the ganged connector to provide retention in lieu of an assembled banana split nut. As shown in FIG. 6H, the mating flange 220 can have a full wall separating mounting holes for assembled banana split nuts and the mounting holes can be partially threaded circumferentially, e.g., a portion of the thread can be removed along a longitudinal axis of the mating flange 220. Such a configuration can allow an assembled banana split nut to be secured via a quarter turn of the assembled banana split nut.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A clamshell apparatus, comprising:
a first segment comprising a first one or more mating pegs and a first threaded portion; and
a second segment comprising a first one or more mating slots and a second threaded portion;
wherein the first segment and the second segment are configured to be assembled via a press-fit of the first segment to the second segment over a banana plug via the first one or more mating pegs arranged on the first segment and corresponding to the first one or more mating slots arranged on the second segment; and
wherein, when assembled, the first threaded portion and the second threaded portion are aligned to form a threaded fastener configured to retain the banana plug when engaged with a corresponding mating flange via the threaded fastener.

2. The clamshell apparatus of claim 1,
wherein the first one or more mating pegs includes a beveled top portion configured to ease assembly with the first one or more mating slots.

3. The clamshell apparatus of claim 2,
wherein the first one or more mating pegs includes a beveled shoulder corresponding to a beveled opening of the first one or more mating slots.

4. The clamshell apparatus of claim 1,
wherein the first segment further comprises a second one or more mating slots; and
wherein the second segment further comprises a second or more mating pegs corresponding to the second one or more mating slots.

5. The clamshell apparatus of claim 1,
wherein, when assembled, the clamshell apparatus includes a tapered inner diameter configured to allow for a varying mating depth to the banana plug.

6. The clamshell apparatus of claim 1,
wherein, when assembled, the clamshell apparatus includes a tapered outer diameter configured to allow the clamshell apparatus to self-center in the corresponding mounting flange.

7. The clamshell apparatus of claim 1,
wherein, when assembled, the clamshell apparatus includes a retaining lip configured to retain the banana plug in the clamshell apparatus.

8. The clamshell apparatus of claim 1,
wherein the first segment includes a first portion of a hex pattern; and
wherein the second segment a second portion of a hex pattern; and
wherein, when assembled, the hex pattern forms a nut design configured to support a wrench grip for tightening in the corresponding mounting flange via the threaded fastener.

9. The clamshell apparatus of claim 1,
wherein the first segment includes a first portion of a radial knurling pattern; and
wherein the second segment a second portion of a radial knurling pattern; and
wherein, when assembled, the radial knurling pattern forms a grip configured to support hand tightening for tightening in the corresponding mounting flange via the threaded fastener.

10. The clamshell apparatus of claim 1,
wherein the first threaded portion and the second threaded portion are dual-chased threads.

11. The clamshell apparatus of claim 1,
wherein the first threaded portion and the second threaded portion are at least one of:
single-chased threads;
buttress threads; or
cut down threads.

12. The clamshell apparatus of claim 1,
wherein the first threaded portion and the second threaded portion are buttress threads with an asymmetric profile.

13. A banana plug retention system, comprising:
a first clamshell apparatus, comprising:
a first segment comprising a first one or more mating pegs and a first threaded portion; and
a second segment comprising a first one or more mating slots and a second threaded portion; and
a mating flange, comprising:
at least first internal threads configured to mate to the first clamshell apparatus;
one or more mounting holes configured to mount the mating flange over a banana socket;
wherein the first segment and the second segment are configured to be assembled via a press-fit of the first segment to the second segment over a banana plug via the first one or more mating pegs arranged on the first segment and corresponding to the first one or more mating slots arranged on the second segment; and
wherein, when assembled, the first threaded portion and the second threaded portion are aligned to form a threaded fastener configured to retain the banana plug when engaged with the mating flange via the threaded fastener and first internal threads.

14. The banana plug retention system of claim 13,
wherein the mating flange further comprises second internal threads configured to mat to a second clamshell apparatus.

15. The banana plug retention system of claim 14,
wherein the mating flange includes a center wall between the first internal threads and the second internal threads.

16. The banana plug retention system of claim 14,
wherein the mating flange includes a partial wall between the first internal threads and the second internal threads to allow use of a ganged connector.

17. The banana plug retention system of claim 13,
wherein the mating flange further comprises one or more centering pins configured to guide the banana plug into the banana socket.

18. The banana plug retention system of claim 13,
wherein the first internal threads are partially threaded circumferentially.

19. The banana plug retention system of claim 13,
wherein the first internal threads are dual-chased threads.

20. The banana plug retention system of claim 13,
wherein the first internal threads are buttress threads with an asymmetric profile.
